(19) United States
(12) Patent Application Publication
(10) Pub. No.: US 2026/0302640 A1
(43) Pub. Date: Oct. 1, 2026

(54) COAXIAL POLARIZER AND MULTIBAND ANTENNA COMPRISING SAME

(71) Applicant: INTELLIAN TECHNOLOGIES, INC., Pyeongtae-si (KR)

(72) Inventors: Woo Chang CHOI, Osan-si (KR); Chang Hyun LEE, Icheon-si (KR)

(21) Appl. No.: 18/881,756

(22) PCT Filed: Jun. 30, 2023
(86) PCT No.: PCT/KR2023/009266

§ 371 Date: Jan. 7, 2025

(30) Foreign Application Priority Data
Nov. 25, 2022 (KR) 10-2022-0160705

(51) Int. Cl. H01Q 15/24; H01Q 5/47; H01Q 5/55; H01Q 19/19

(52) U.S. Cl. CPC H01Q 15/24; H01Q 5/47; H01Q 5/55; H01Q 19/193

(57) ABSTRACT

A coaxial polarizer and a multiband antenna comprising the same are disclosed. The multiband antenna comprises: a first waveguide; a second waveguide, which shares the same axis with the first waveguide and has a greater diameter than the first waveguide; a coaxial polarizer which is provided between the first and second waveguides; a feed horn which is provided at one side of the first and second waveguides; and a reflector which is provided at the other side of the first and second waveguides, wherein the polarizer comprises at least one polarizer fixed to each of the first and second waveguides.

### TECHNICAL FIELD

The following embodiments relate to a coaxial polarizer and a multiband antenna including the same.

### BACKGROUND ART

Polarization is a phenomenon in which an electric field vibrates in a certain direction in an electromagnetic wave, and the electric field may also rotate in addition to vibrating in a one-dimensional linear direction. The electromagnetic wave is a type of wave that is propagated while an electric field and a magnetic field vibrate. The direction in which the electric field and the magnetic field vibrate is perpendicular to the traveling direction of the electromagnetic wave.

A polarizer is an electromagnetic passive element that responds to and absorbs only components that vibrate in the same direction in an incident electromagnetic wave and lets other components pass through.

An antenna is a device configured to transmit and receive a wave of a set band. Typically, a plurality of antennas is required to transmit and receive a plurality of waves each having a different band. However, using the plurality of antennas may increase space inefficiency and costs and cause difficulties in maintenance or repair. Accordingly, a single antenna including a plurality of transceivers each having a different band is being developed. Although single antennas commonly use waveguides in a coaxial structure, there has been a problem where, when a polarizer is provided in a coaxial structure, a loss value increases due to vibration and shock caused in antennas.

Meanwhile, Korean Patent Publication No. 10-1757681 discloses a satellite communication antenna capable of receiving multiband signals. The antenna disclosed in the present application is configured to transmit and receive different bands by adjusting the orientation of a sub-reflecting board while a plurality of feedhorns is installed fixedly in a main reflecting board.

The above description is information the inventor(s) acquired during the course of conceiving the present disclosure, or already possessed at the time, and was not necessarily publicly known before the present application was filed.

### DISCLOSURE OF THE INVENTION

### Technical Goals

An aspect aims to provide a coaxial polarizer that may compensate the vibration and shock to reduce a wave loss value and may fix coaxial waveguides without an additional fixing component to reduce the complexity and weight of a system and a multiband antenna including the same.

The technical aspects obtainable from the present disclosure are non-limited by the above-mentioned technical aspects, and other unmentioned technical aspects can be clearly understood from the following description by those having ordinary skill in the technical field to which the present disclosure pertains.

### Technical Solutions

According to embodiments, a coaxial polarizer and a multiband antenna including the same are disclosed. A coaxial polarizer includes a first polarizer having a hollow into which a guide body is inserted and a second polarizer that extends in a longitudinal direction of the guide body from the first polarizer and includes a plurality of stepped elements having their heights from the guide body being different from one another, in which their heights change as the plurality of stepped elements is away from the first polarizer, and the first polarizer is fixed to the guide body to prevent shock or vibration.

According to an aspect, the second polarizer may extend symmetrically to both ends in the longitudinal direction of the guide body from the first polarizer.

According to an aspect, a first groove that penetrates the first polarizer may be formed, and a fastener may be inserted into the first groove to fix the guide body and the first polarizer. A second groove that penetrates the second polarizer may be formed, and a fastener may be inserted into the second groove to fix the guide body and the second polarizer.

A multiband antenna includes a first waveguide, a second waveguide that shares the same axis as that of the first waveguide and has a diameter greater than that of the first waveguide, a coaxial polarizer provided between the first waveguide and the second waveguide, a feedhorn provided on one side of the first waveguide and the second waveguide, and a reflecting board provided on the other side of the first waveguide and the second waveguide, in which at least one coaxial polarizer is each fixed to the first waveguide and the second waveguide.

According to an aspect, the coaxial polarizer may include a first polarizer formed to fill up between an outer circumferential surface of the first waveguide and an inner circumferential surface of the second waveguide that shares the same axis as that of the first waveguide and has a diameter greater than that of the first waveguide and a second polarizer that extends in a longitudinal direction of the first waveguide from the first polarizer.

According to an aspect, the second polarizer may include a plurality of stepped elements having their heights from the first waveguide being different from one another, in which their heights change as the plurality of stepped elements is away from the first polarizer.

According to an aspect, their heights from the first waveguide may decrease as the plurality of stepped elements is away from the first polarizer.

According to an aspect, the height of the second polarizer from the first waveguide may constantly decrease as moving away from the first polarizer.

According to an aspect, the second polarizer may extend symmetrically to both ends in the longitudinal direction of the first waveguide from the first polarizer.

According to an aspect, the second polarizer may include at least one front polarization member disposed in a direction from the first polarizer to the reflecting board and at least one rear polarization member disposed in a direction from the first polarizer to the feedhorn.

According to an aspect, the at least one front polarization member may include a first polarization element and a second polarization element that is symmetrical to the first polarization element based on a central axis of the first waveguide, and the at least one rear polarization member may include a third polarization element and a fourth polarization element that is symmetrical to the third polarization element based on the central axis of the first waveguide.

According to an aspect, a slit may be formed between the first polarization element and the second polarization element, and a slit may be formed between the third polarization element and the fourth polarization element.

According to an aspect, the coaxial polarizer may further include a third polarizer that surrounds the outer circumferential surface of the first waveguide, and the first polarizer and the second polarizer may be provided on an outer circumferential surface of the third polarizer.

According to an aspect, the first polarizer may include an extension such that its length may extend in the longitudinal direction of the first waveguide.

According to an aspect, a first groove that penetrates from an outer side of the second waveguide to the first polarizer may be formed, and a fastener may be inserted into the first groove to fix the second waveguide and the first polarizer.

According to an aspect, a second groove that penetrates from a surface of the second polarizer to the first waveguide may be formed, and a fastener may be inserted into the second groove to fix the first waveguide and the second polarizer.

According to an aspect, a compensator where a plurality of recesses formed in a longitudinal direction is disposed at predetermined intervals may be formed to compensate for a phase delay on an outer circumferential surface of the first polarizer.

According to an aspect, the first polarizer and the second polarizer may be integrally molded.

### Effects of the Invention

As described above, according to embodiments, a coaxial polarizer and a multiband antenna including the same may compensate the vibration and shock occurring in waveguides to reduce a wave loss value and reduce the complexity and weight of a system.

The effects of a coaxial polarizer and a multiband antenna including the same, according to an embodiment, may not be limited to the above-mentioned effects, and other unmentioned effects may be clearly understood from the following description by one of ordinary skill in the art.

### BRIEF DESCRIPTION OF DRAWINGS

FIG. 1 is a diagram schematically illustrating a configuration of a multiband antenna according to an embodiment.

FIG. 2 is a diagram illustrating a configuration of a coaxial polarizer according to an embodiment.

FIGS. 3A and 3B are diagrams each illustrating a configuration of a coaxial polarizer including an extension, according to another embodiment.

FIGS. 4A and 4B are diagrams each illustrating the shape of a coaxial polarizer provided between a first waveguide and a second waveguide, according to an embodiment.

FIG. 5 is a diagram illustrating a configuration of a coaxial polarizer according to another embodiment.

FIGS. 6A and 6B are diagrams each illustrating a configuration of a second polarizer of a coaxial polarizer, according to an embodiment.

FIG. 7 is a diagram illustrating a configuration of a coaxial polarizer further including a third polarizer, according to an embodiment.

FIG. 8 is a graph measuring an axial ratio of circular polarization generated in the coaxial polarizer according to an embodiment.

FIG. 9 is a graph measuring an isolation value and a return loss value of circular polarization generated in the coaxial polarizer according to an embodiment.

FIG. 10 is a graph measuring an axial ratio of circular polarization generated in a coaxial polarizer including a feedhorn, according to an embodiment.

The accompanying drawings illustrate preferred embodiments of the present invention and are provided together with the detailed description for better understanding of the technical idea of the present invention. Therefore, the present invention should not be construed as being limited to the embodiments set forth in the drawings.

### BEST MODE FOR CARRYING OUT THE INVENTION

Hereinafter, embodiments are described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. When one component is described as being “connected,” “coupled,” or “attached” to another component, it should be understood that one component may be connected or attached directly to another component, and an intervening component may also be “connected,” “coupled,” or “attached” to the components.

A component, which has the same common function as a component included in any one embodiment, will be described by using the same name in other embodiments. Unless disclosed to the contrary, the configuration disclosed in any one embodiment may be applied to other embodiments, and the specific description of the repeated configuration will be omitted.

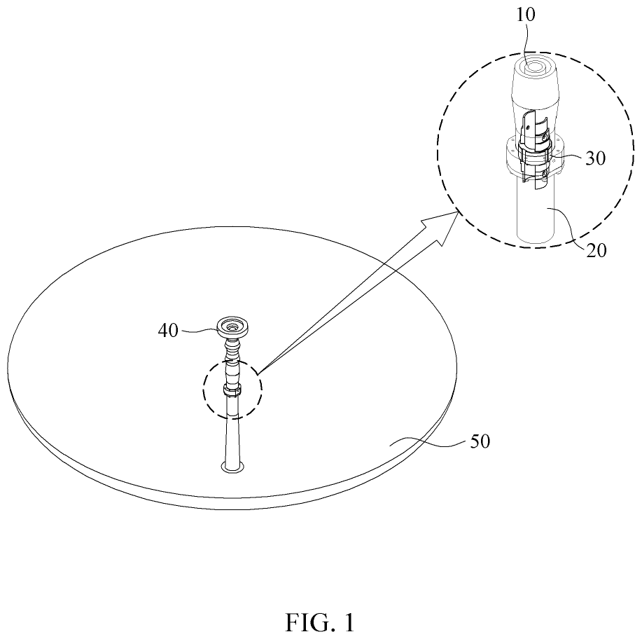

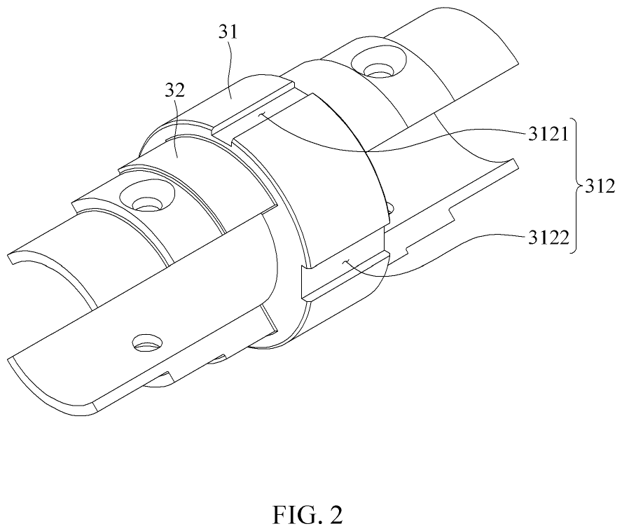

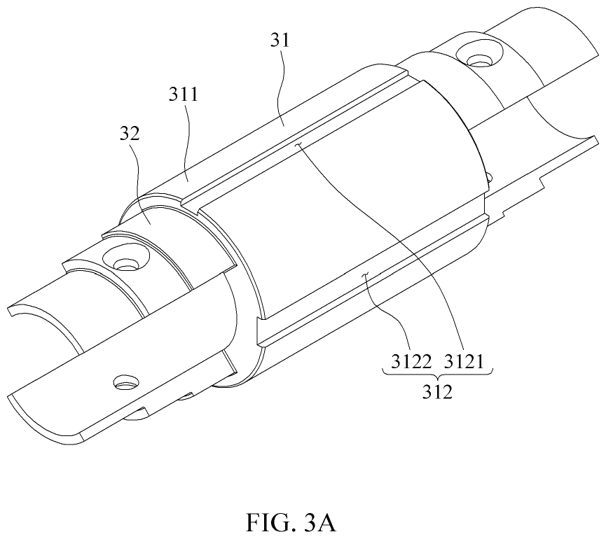

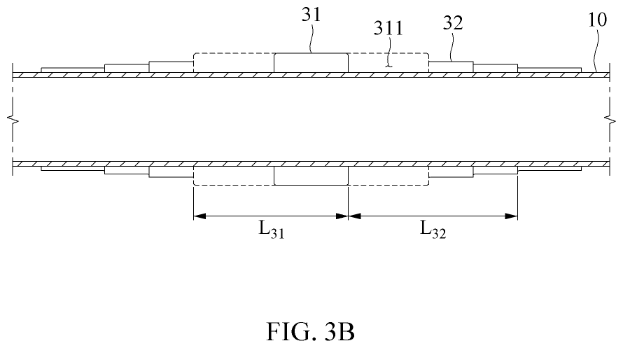

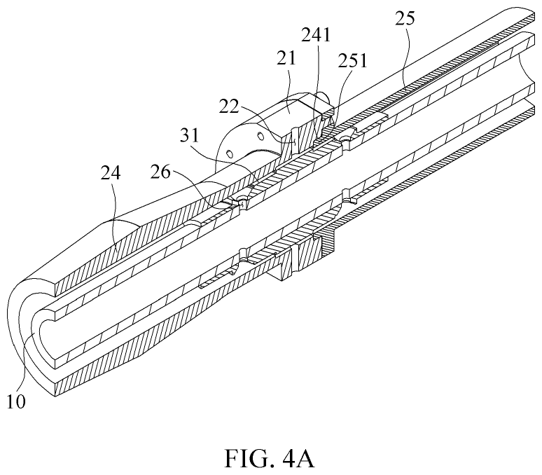

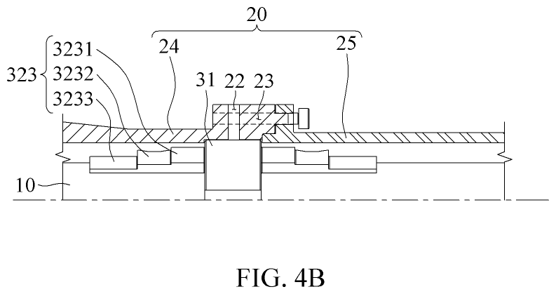

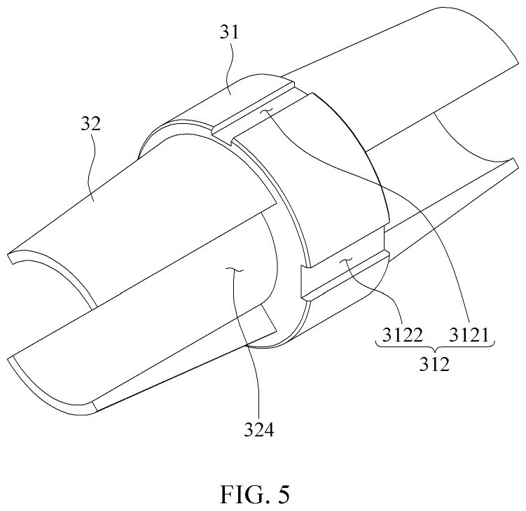

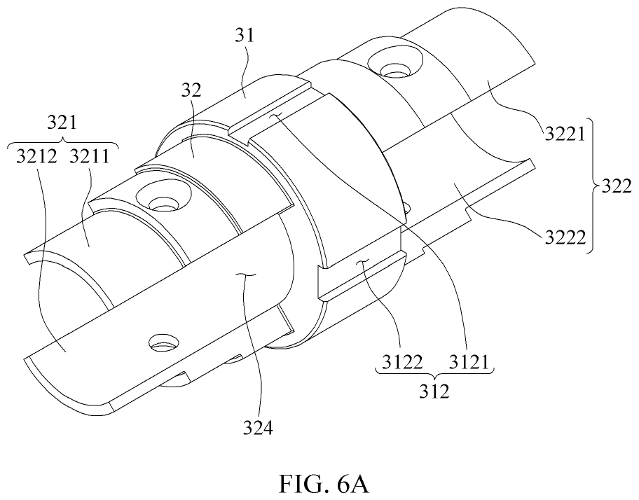

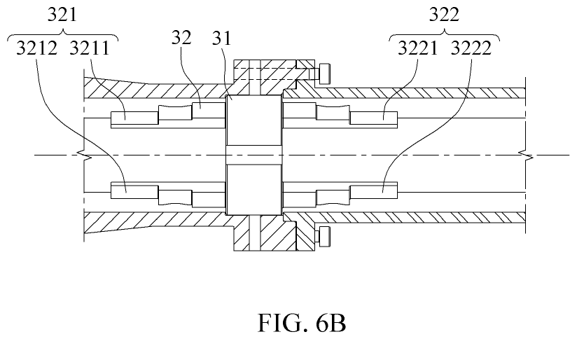

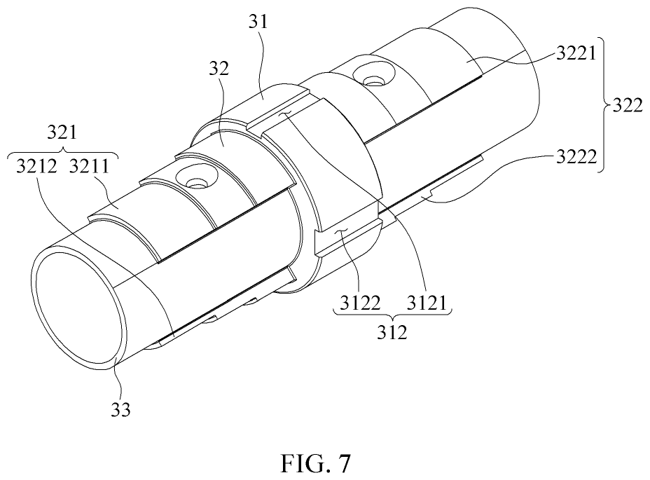

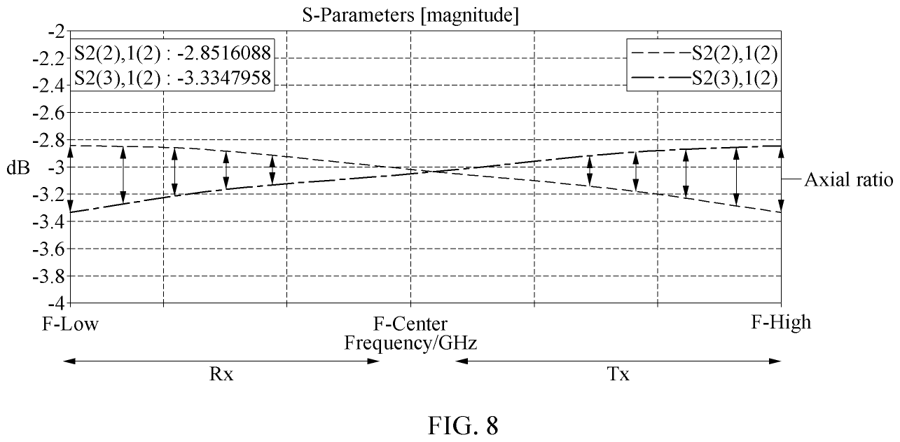

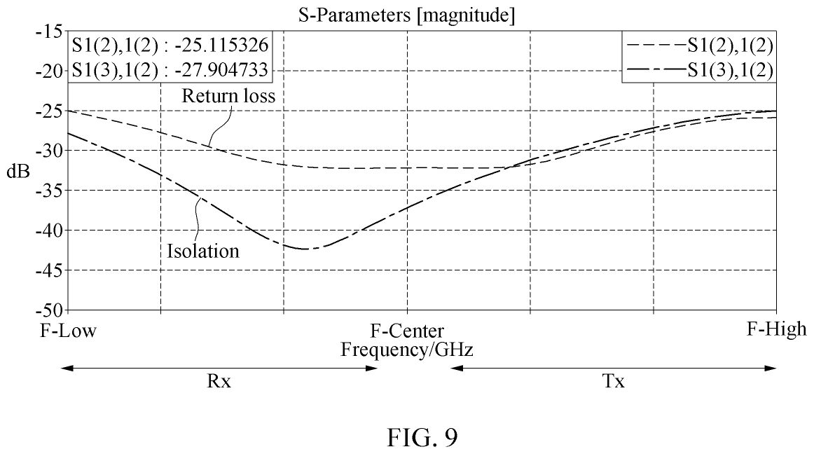

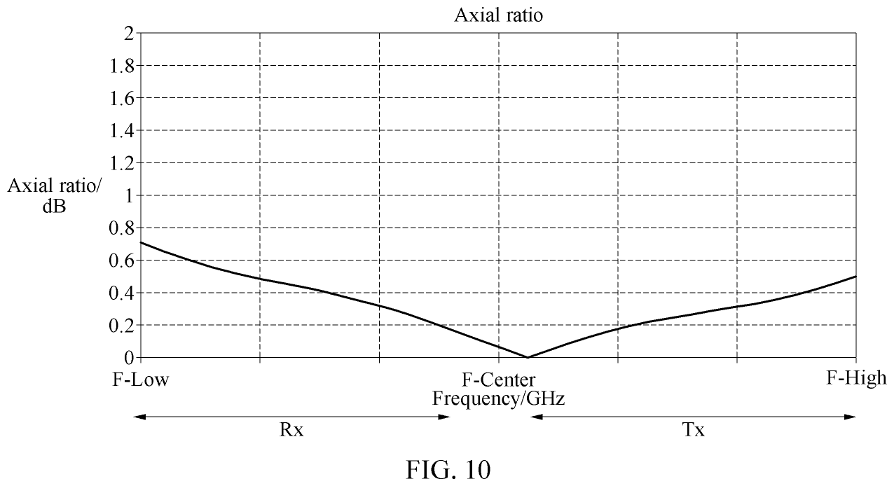

A coaxial polarizer and a multiband antenna including the same are described with reference to the drawings. For reference, FIG. 1 is a diagram schematically illustrating a configuration of a multiband antenna according to an embodiment, FIG. 2 is a diagram illustrating a configuration of a coaxial polarizer according to an embodiment, FIGS. 3A and 3B are diagrams each illustrating a configuration of a coaxial polarizer including an extension, according to another embodiment, FIGS. 4A and 4B are diagrams each illustrating the shape of a coaxial polarizer provided between a first waveguide and a second waveguide, according to an embodiment, FIG. 5 is a diagram illustrating a configuration of a coaxial polarizer according to another embodiment, FIGS. 6A and 6B are diagrams each illustrating a configuration of a second polarizer of a coaxial polarizer, according to an embodiment, FIG. 7 is a diagram illustrating a configuration of a coaxial polarizer further including a third polarizer, according to an embodiment, FIG. 8 is a graph measuring an axial ratio of circular polarization generated in the coaxial polarizer according to an embodiment, FIG. 9 is a graph measuring an isolation value and a return loss value of circular polarization generated in the coaxial polarizer according to an embodiment, and FIG. 10 is a graph measuring an axial ratio of circular polarization generated in a coaxial polarizer including a feedhorn, according to an embodiment.

According to an embodiment, a coaxial polarizer 30 may be provided in a coaxial guide body and may polarize a phase of a wave inside a guide body. The coaxial polarizer 30 may include a first polarizer 31 having a hollow into which a guide body may be inserted and a second polarizer 32 that extends in a longitudinal direction of the guide body from the first polarizer 31 and includes a plurality of stepped elements having their heights from the guide body being different from one another, in which their heights change as the plurality of stepped elements is away from the first polarizer 31, and the first polarizer 31 is fixed to the guide body to prevent shock or vibration.

Referring to FIG. 1, a multiband antenna 1, according to an embodiment, may be configured by including a first waveguide 10, a second waveguide 20, the coaxial polarizer 30, a feedhorn 40, and a reflecting board 50.

According to an embodiment, the first waveguide 10 may pass a first band signal in an electromagnetic wave form. For example, the first waveguide 10 may be a hollow conductive pipe with its center empty. In addition, the first band signal may be the Ka-band frequency having a band from 26.5 GHz to 40 GHz, but examples are not limited thereto.

According to an embodiment, the second waveguide 20 may pass a second band signal. The second waveguide 20 may share the same axis as that of the first waveguide 10 and may have a diameter greater than that of the first waveguide 10. In other words, the first waveguide 10 is provided inside the second waveguide 20. In addition, the second band signal may be the X-band frequency having a band from 8 GHz to 12 GHz, but examples are not limited thereto. A frequency having a band relatively lower than the first band signal may be applied.

Referring to FIG. 2, the coaxial polarizer 30, according to an embodiment, may be provided between the first waveguide 10 and the second waveguide 20. At least one coaxial waveguide 30 is provided and may be each fixed to the first waveguide 10 and the second waveguide 20. The coaxial polarizer 30 may include the first polarizer 31 and the second polarizer 32.

According to an embodiment, the first polarizer 31 may be formed to fill up between the outer circumferential surface of the first waveguide 10 and the inner circumferential surface of the second waveguide 20. The first polarizer 31 is provided between the outer circumferential surface of the first waveguide 10 and the inner circumferential surface of the second waveguide 20 to be fixed to the first waveguide 10 and the second waveguide 20 such that the first waveguide 10 and the second waveguide 20 in a coaxial structure may be fixed to their regular positions. The first polarizer 31 may prevent the performance deterioration of the multiband antenna 1 due to vibration and shock by fixing the first waveguide 10 and the second waveguide 20 and preventing vibration and alleviating shock in the multiband antenna 1. In this case, the first polarizer 31 is formed as a dielectric such that the second band signal that passes inside the second waveguide 20 may be passed.

In addition, according to an embodiment, the length of the first polarizer 31 may extend in the longitudinal direction of the first waveguide 10. For example, referring to FIGS. 3A and 3B, the first polarizer 31 may include an extension 311 to extend in the longitudinal direction of the first waveguide 10. The length of the first polarizer 31 extends to the extension 311 such that the first waveguide 10 and the second waveguide 20 may be more stably fixed. Although the example of a length L31 of the first polarizer 31 with its length extended to be longer than a length L32 is illustrated in the drawings, the length of the first polarizer 31 may be flexibly changed to an optimal length that may prevent vibration and alleviate shock depending on operating environments and design conditions of the multiband antenna 1.

In addition, according to an embodiment, the first polarizer 31 may include at least one compensator 312. The compensator 312 may be configured with a plurality of recesses formed on the outer circumferential surface of the first polarizer 31, and these recesses may be recessed at a predetermined depth from the surface of the first polarizer 31. The plurality of recesses is arranged at predetermined intervals and may compensate for a phase delay. At a part where the compensator 312 is formed, the second band signal that passes inside the second polarizer 20 may pass in the air without a phase delay and thus may have effects to partially compensate for a phase delay due to the coaxial polarizer 30. For example, the plurality of recesses may include a first recess 3121, a second recess 3122, a third recess 3123, and a fourth recess 3124 respectively in 0-, 90-, 180-, and 270-degree directions based on the central axis of the second waveguide 20. The positions where the recesses are formed may be flexibly changed depending on phase delay compensation values of the multiband antenna 1.

Referring to FIGS. 4A and 4B, according to an embodiment, a first groove 22 that penetrates from the outer side of the second waveguide 20 to the first polarizer 31 may be formed in the multiband antenna 1. A fastener may be inserted into the first groove 22, and fastener coupling may enable the first polarizer 31 between the second waveguide 20 and the first waveguide 10 to be fixed to its regular position. In this case, the fastener commonly and widely refers to a mechanical coupling element, such as a bolt, a screw, a nut, a washer, a nail, a rivet, or an anchor, which is not limited to a specified element, and various elements may be used. In addition, instead of such a mechanical coupling element, a chemical coupling element, such as an adhesive, may be used. Hereinafter, for ease of description, the term “fastener” is uniformly used.

In this case, a protrusion 21 in a ring shape surrounding the second waveguide 20 may be formed on the outer side of the second waveguide 20, and the first groove 22 may be formed on a surface of the protrusion 21. As the protrusion 21 is formed, a minimum length of the fastener that is inserted into the first groove 22 may be secured. In addition, the second waveguide 20 may be separated such that the first polarizer 31 and the second polarizer 32 may be inserted into the inside thereof. For example, the second waveguide 20 may include a front guide body 24 including the protrusion 21 and a rear guide body 25 and may be formed by coupling the front guide body 24 to the rear guide body 25. In this case, the front guide body 24 may refer to the second waveguide 20 arranged in a direction from the first polarizer 31 toward the reflecting board 50, and the rear guide body 25 may refer to the second waveguide 20 arranged in a direction from the first polarizer 31 toward the feedhorn 40. The first polarizer 31 may be inserted into the inside of the front guide body 24, the fastener may be coupled thereto through the first groove 22, and then, the front guide body 24 may be coupled to the rear guide body 25. In this case, a side surface groove 23 may be formed on a side surface of the protrusion 21 such that the front guide body 24 may be coupled to the rear guide body 25. The fastener may be inserted into the side surface groove 23 such that the front guide body 24 may be coupled to the rear guide body 25. In addition, a catching groove 241 may be formed on one side of the front guide body 24, and a catching protrusion 251 may be formed on one side of the rear guide body 25 such that a central axis may be easily aligned when the front guide body 24 is coupled to the rear guide body 25.

In addition, according to an embodiment, a second groove 26 that penetrates from a surface of the second polarizer 32 to the first waveguide 10 may be formed in the multiband antenna 1. A fastener may be inserted into the second groove 26, and fastener coupling may enable the second polarizer 32 between the first waveguide 10 and the second waveguide 20 to be fixed to its regular position. For example, the second groove 26 may be formed in a second step 3232 of a rear polarization member 322 and a front polarization member 321 or in the center. In addition, other than said configuration, there may be a configuration that fixes or presses the first waveguide 10 and the second waveguide 20 to the coaxial polarizer 30 in an assembly coupling manner using a bonding element in a clamp shape.

According to an embodiment, the second polarizer 32 may extend in the longitudinal direction of the first waveguide 10 from the first polarizer 31. The second polarizer 32, provided in a traveling direction of the second band signal, may delay a phase of the second band signal to convert linear polarization into circular polarization or circular polarization into linear polarization. In addition, the second polarizer 32 is also formed as a dielectric such that the second band signal that passes inside the second waveguide 20 may be passed. The dielectric rate of a dielectric configuring the first polarizer 31 and the second polarizer 32 may be flexibly changed depending on the specification and design conditions of the multiband antenna 1.

For example, according to an embodiment, the second polarizer 32 may include a plurality of stepped elements 323 with their heights from the first waveguide 10 being different from one another and may extend in the longitudinal direction of the first waveguide 10 from the first polarizer 31. In this case, the heights refer to distances to the top of the stepped elements 323 from the axis of the first waveguide 10. The heights of the stepped elements 323 may change as moving away from the first polarizer 31. Specifically, their heights from the first waveguide 10 may decrease as the stepped elements 323 are away from the first polarizer 31. The plurality of stepped elements 323 may include a first step 3231, the second step 3232, and a third step 3233 in a direction away from the first polarizer 31 to the longitudinal direction of the first waveguide 10, and the heights may decrease in the order from the first step 3231, the second step 3232, and the third step 3233. However, this is just an example, and the number of the stepped elements 323 may be flexibly changed.

In addition, according to an embodiment, the height of the second polarizer 32 from the first waveguide 10 may constantly decrease as moving away from the first polarizer 31. Referring to FIG. 5, the height of the second polarizer 32 may linearly decrease. However, this is just an example, and how the height decreases may be flexibly changed.

In addition, according to an embodiment, the second polarizer 32 may extend symmetrically to both ends in the longitudinal direction of the first waveguide 10 from the first polarizer 31. Referring to FIGS. 6A and 6B, for example, the second polarizer 32 may include the front polarization member 321 and the rear polarization member 322. In this case, the front polarization member 321 may refer to a polarization member arranged in a direction from the first polarizer 31 toward the reflecting board 50, and the rear polarization member 322 may refer to a polarization member arranged in a direction from the first polarizer 31 toward the feedhorn 40.

In addition, according to an embodiment, the front polarization member 321 may include a first polarization element 3211 and a second polarization element 3212. In this case, the second polarization element 3212 may be symmetrically provided to the first polarization element 3211 based on the central axis of the first waveguide 10. For example, they are symmetrically provided such that the first polarization element 3211 may be positioned in a 0-degree direction and the second polarization element 3212 may be positioned in a 180-degree direction based on the circumference of the first waveguide 10. In addition, according to an embodiment, the rear polarization member 322 may include a third polarization element 3221 and a fourth polarization element 3222. Like the first polarization element 3211 and the second polarization element 3212, the third polarization element 3221 and the fourth polarization element 3222 may be provided such that the fourth polarization element 3222 may be symmetrical to the third polarization element 3221 based on the central axis of the first waveguide 10.

In addition, a slit 324 may be formed between the first polarization element 3211 and the second polarization element 3212 or may be formed between the third polarization element 3221 and the fourth polarization element 3222. The slit 324 may be a space not including the first polarization element 3211, the second polarization element 3212, the third polarization element 3221, and the fourth polarization element 3222 in a space between the first waveguide 10 and the second waveguide 20. At a part where the slit 324 is formed, the second band signal that passes inside the second waveguide 20 may be traveled without a phase delay.

In addition, according to an embodiment, the coaxial polarizer 30 may further include a third polarizer 33. Referring to FIG. 7, the third polarizer 33 may be formed to surround the first waveguide 10. In other words, the third polarizer 33 may surround the first waveguide 10, and the first polarizer 31 and the second polarizer 32 may be provided on the outer circumferential surface of the third polarizer 33. If the first polarizer 31 and the second polarizer 32 are directly provided on the outer circumferential surface of the first waveguide 10, there may be a gap, instead of full contact, due to unevenness of the surfaces of the first polarizer 31 and the second polarizer 32 or the outer circumferential surface of the first waveguide 10. As the third polarizer 33 is provided, the first polarizer 31 may effectively touch the second polarizer 32.

The first polarizer 31 and the second polarizer 32 may be integrally molded in manufacture. By such a configuration, the first polarizer 31 and the second polarizer 32 that are integrally molded are inserted into the outer circumferential surface of the first waveguide 10, and the second waveguide 20 is coupled thereto such that the productivity of the multiband antenna 1 may be improved.

Hereinafter, the performance of the multiband antenna 1, according to an embodiment, is described in detail with reference to the drawings.

FIG. 8 is a graph illustrating a result of testing the coaxial polarizer 30 not including the feedhorn 40. It is confirmed that an axial ratio of the coaxial polarizer 30 of the multiband antenna 1 is less than or equal to 0.6 dB in all areas at the frequency from the Rx band to the Tx band of the second band signal. It is confirmed that circular polarization generated in the coaxial polarizer 30 of the multiband antenna 1 has an excellent axial ratio close to a circular shape.

In addition, referring to FIG. 9, it is confirmed that a return loss value indicates about −25 dB in the Rx band and about −25 dB in the Tx band, and an isolation value indicates about −28 dB in the Rx band and about −25 dB in the Tx band.

FIG. 10 is a graph illustrating a result of testing the coaxial polarizer 30 including the feedhorn 40. It is confirmed that the multiband antenna 1 including the feedhorn 40 has a coaxial ratio of about 0.7 dB at the F-low point of the Rx band of the second band signal and has a coaxial ratio of about 0.5 dB at the F-high point of the Tx band thereof.

As such, it is confirmed that the multiband antenna 1, according to an embodiment, has an excellent axial ratio property, a reflection loss, and an isolation value that are optimized for satellite communication.

According to embodiments, the coaxial polarizer 30 is fixed between the first waveguide 10 and the second waveguide 20 such that the multiband antenna 1 may stably fix the first waveguide 10 and the second waveguide 20 without an additional fixing member.

A number of embodiments have been described above. Nevertheless, it should be understood that various modifications may be made to these embodiments. Suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

1. A coaxial polarizer comprising:
a first polarizer having a hollow into which a guide body is inserted; and
a second polarizer that extends in a longitudinal direction of the guide body from the first polarizer and comprises a plurality of stepped elements having their heights from the guide body being different from one another,
wherein their heights change as the plurality of stepped elements is away from the first polarizer, and
the first polarizer is fixed to the guide body to prevent shock or vibration.

2. The coaxial polarizer of claim 1, wherein
the second polarizer extends symmetrically to both ends in the longitudinal direction of the guide body from the first polarizer.

3. The coaxial polarizer of claim 1, wherein
a first groove that penetrates the first polarizer is formed, and a fastener is inserted into the first groove to fix the guide body and the first polarizer, and
a second groove that penetrates the second polarizer is formed, and a fastener is inserted into the second groove to fix the guide body and the second polarizer.

4. A multiband antenna comprising:
a first waveguide;
a second waveguide that shares the same axis as that of the first waveguide and has a diameter greater than that of the first waveguide;
a coaxial polarizer provided between the first waveguide and the second waveguide;
a feedhorn provided on one side of the first waveguide and the second waveguide; and
a reflecting board provided on the other side of the first waveguide and the second waveguide,
wherein at least one coaxial polarizer is each fixed to the first waveguide and the second waveguide.

5. The multiband antenna of claim 4, wherein
the coaxial polarizer comprises:
a first polarizer formed to fill up between an outer circumferential surface of the first waveguide and an inner circumferential surface of the second waveguide that shares the same axis as that of the first waveguide and has a diameter greater than that of the first waveguide; and
a second polarizer that extends in a longitudinal direction of the first waveguide from the first polarizer.

6. The multiband antenna of claim 5, wherein
the second polarizer comprises a plurality of stepped elements having their heights from the first waveguide being different from one another, wherein their heights change as the plurality of stepped elements is away from the first polarizer.

7. The multiband antenna of claim 6, wherein
their heights from the first waveguide decrease as the plurality of stepped elements is away from the first polarizer.

8. The multiband antenna of claim 5, wherein
a height of the second polarizer from the first waveguide constantly decreases as moving away from the first polarizer.

9. The multiband antenna of claim 5, wherein
the second polarizer extends symmetrically to both ends in the longitudinal direction of the first waveguide from the first polarizer.

10. The multiband antenna of claim 9, wherein
the second polarizer comprises:
at least one front polarization member disposed in a direction from the first polarizer to the reflecting board; and
at least one rear polarization member disposed in a direction from the first polarizer to the feedhorn.

11. The multiband antenna of claim 10, wherein
the at least one front polarization member comprises a first polarization element and a second polarization element that is symmetrical to the first polarization element based on a central axis of the first waveguide, and
the at least one rear polarization member comprises a third polarization element and a fourth polarization element that is symmetrical to the third polarization element based on the central axis of the first waveguide.

12. The multiband antenna of claim 11, wherein
a slit is formed between the first polarization element and the second polarization element, and a slit is formed between the third polarization element and the fourth polarization element.

13. The multiband antenna of claim 5, wherein
the coaxial polarizer further comprises a third polarizer that surrounds the outer circumferential surface of the first waveguide, and the first polarizer and the second polarizer are provided on an outer circumferential surface of the third polarizer.

14. The multiband antenna of claim 5, wherein
the first polarizer comprises an extension such that its length extends in the longitudinal direction of the first waveguide.

15. The multiband antenna of claim 5, wherein
a first groove that penetrates from an outer side of the second waveguide to the first polarizer is formed, and a fastener is inserted into the first groove to fix the second waveguide and the first polarizer.

16. The multiband antenna of claim 5, wherein
a second groove that penetrates from a surface of the second polarizer to the first waveguide is formed, and a fastener is inserted into the second groove to fix the first waveguide and the second polarizer.

17. The multiband antenna of claim 5, wherein
a compensator where a plurality of recesses formed in a longitudinal direction is disposed at predetermined intervals is formed to compensate for a phase delay on an outer circumferential surface of the first polarizer.

18. The multiband antenna of claim 5, wherein
the first polarizer and the second polarizer are integrally molded.
